(19) United States
(12) Patent Application Publication
(10) Pub. No.: US 2006/0047543 A1
(43) Pub. Date: Mar. 2, 2006

(54) Electronic emergency response management system with automated rule-based alert notifications and response deployment

(76) Inventor: Thomas H. Moses, Bolton, MA (US)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 10/930,281

(22) Filed: Aug. 30, 2004

(51) Int. Cl. G06F 9/44; G21C 17/00; G06F 7/00; G08B 23/00; G06F 17/50

(52) U.S. Cl. 705/7; 702/182; 340/573.1; 340/500; 235/376

(57) ABSTRACT

A computerized method and related system (10) for identifying matches between emergency response units (ERU) and stationary response units (SRU) includes identifying a group of emergency response units, wherein each emergency and stationary response unit has particular physical attributes. A beacon (20, 36) is installed on each emergency response unit in the group and emits a unique identifiable signal. A database (DB) is maintained for identifying each stationary and emergency response unit, their corresponding physical attributes; and a location based on the unique identifiable signal. The database can then be accessed via a call center (12) to determine area response capabilities for a particular type of calamity needing physical attributes provided by the group of emergency response units. The database may also monitor critical assets (CA) such as hazardous material to ensure that they are not diverted, and if so what response units need to respond. The database further includes a set of predetermined rules for generating alert notices to owners of critical assets and vulnerable targets. The rules also identify the manner in which response units are to be alerted.

### TECHNICAL FIELD

The present invention resides generally in the art of systems and methods for databases used in emergency response activities. In particular, the present invention is related to a system that allows a user to associate particular events with increased risks of weapons of mass destruction threats or accidents to carriers of hazardous materials and to immediately determine the location of emergency response units or resources and their capabilities, and make an assessment as to which of those units or resources have the ability to respond to the identified threats or accidents in the quickest period of time. Specifically, the present invention allows for the incorporation of pre-defined rules into the system to automatically trigger notifications to the appropriate authorities and initiate deployment of pre-designated response assets.

### BACKGROUND ART

It is believed that there is a serious lack of a coordinated collection of emergency response unit capabilities at a local, municipal, state or even national level. In the event of a catastrophe—such as a natural disaster, industrial accident or terrorist activity—certain types of specialized needs may arise. Presently, to address anticipated and/or unforeseen needs, it is likely that numerous phone calls must be placed in order to find the emergency response unit that can address the specific need. As will be appreciated, this is very time consuming and costly. And in instances where lives are at risk, the ability to respond in a timely manner with the incident-specific equipment is critical.

There are limited technology and unrelated service offerings currently available. Moreover, none of the existing technology is related to the transportation or monitoring of critical assets, such as chemical shipments, transport of weapons of mass destruction or similar threats. In other words, there is presently no known real-time monitoring of critical assets, which if in the wrong hands, could be used in an unintended and harmful manner. And there is no known system that determines what response items are needed if the critical asset is used in an improper way, and which of those assets are closest and can respond in a timely manner. Nor is there a known system that is able to proactively monitor the critical assets in such a way that if a monitored characteristic is not within a predetermined range an alert is immediately generated. Therefore, based upon the foregoing, there is a need to provide emergency response planners and agencies greater control of these events by providing fast access to resources and information associated with weapons of mass destruction, hazardous material release events and the like. And there is a need in the art to monitor for a pattern of alerts for the purpose of predicting risks of a terrorist event or accidents to carriers of hazardous materials. There is a further need for assessing whether vulnerable targets are at risk, automating the reporting of threats, and initiating response deployment.

### DISCLOSURE OF INVENTION

In light of the foregoing, it is a first object of the present invention to provide an electronic emergency response management system with an automated rule-based alert notification and response deployment feature and method for using the same.

It is another aspect of the present invention to provide a system, as set forth above, that provides for use of a database for storing and accessing data relating to emergency response units, stationary units and critical assets.

It is a further aspect of the present invention to provide a system, as set forth above, wherein the database includes as a minimum: a notation of the emergency response unit, the stationary unit and the critical asset; the particular capabilities of the response or stationary unit in responding to specific calamities or response activities; the physical attributes of the critical asset; and the locations of the emergency response unit, the stationary unit and the critical asset.

It is yet another aspect of the present invention to provide a system, as set forth above, wherein the locational information is updated instantaneously by a wireless communications link so that the location of the emergency response unit, the resources/inventory of the stationary unit and the location of the critical asset is known at all times. And it is yet another aspect of the invention to provide map information designating the locations of all the response units and critical assets.

It is yet another aspect of the present invention to provide a system, as set forth above, wherein the database is accessible, either via the internet, dedicated telephone lines or other similar communication systems, for the purpose of determining response capabilities in a particular geographic region and, if needed, to dispatch those units to a particular emergency.

It is still another aspect of the present invention to provide a system, as set forth above, wherein the database includes information about stationary response units, their location, their relevance to the emergency response units, their particular capabilities, and their inventory.

It is still a further aspect of the present invention to provide a system, as set forth above, wherein the emergency response units, stationary and the critical assets are provided with a beacon, which may be a wireless or satellite transceiver device that communicates the locational information of the asset or unit and other related information regarding the status of the asset or unit to a call center which may relay the information to another unit.

It is still yet another aspect of the present invention to provide a system, as set forth above, wherein a plurality of sensors are associated with each critical asset and each stationary unit, and wherein the sensors are connected to their respective beacon and allow for transmission of operational information related to the critical asset and stationary unit.

It is still a further aspect of the present invention to provide a system, as set forth above, wherein a processor-based system links the database and communication systems and other mapping information at the call center so as to allow for real-time analysis of emergencies, potential emergencies, two-way communications between the various units and assets, and planning scenarios.

It is yet a further aspect of the present invention to provide a system as set forth above, wherein a telematics provider functions as a conduit between the beacons and associated sensors, and the call center and, if needed, between the call center and the various response units.

It is still another aspect of the present invention to provide a system, as set forth above, wherein the owners of the critical assets, the governmental agencies responsible for the response units, and other interested parties enter “rules” or other criteria into the database and processing system so as to automate the process of generating alert notifications and deploying pre-designated responses.

The foregoing and other aspects of the present invention, which shall become apparent as the detailed description proceeds, are achieved by a computerized method for identifying matches between emergency response units and a response event comprising: identifying a group of emergency response units (ERU), each the emergency response unit having particular physical attributes; installing an ERU beacon on each the ERU, the ERU beacon emitting a unique identifiable ERU signal; maintaining a database identifying each ERU, their corresponding physical attributes, and a location based on the unique identifiable ERU signal; loading into the database a set of rules associated with each the ERU; accessing the database to determine area response capabilities for a particular type of response event needing physical attributes provided by the group of ERUs; applying the unique identifiable ERU signals to the set of rules; and generating at least one alert based upon matching of the unique identifiable ERU signal with at least one of the rules.

Other aspects of the present invention are attained by a system for identifying emergency response capabilities in a geographical area, comprising: a database component operative to maintain an ERU database identifying emergency response units, their physical attributes and their physical location; a communications component for observing physical locations of the emergency response units a rules component operative with the database component; and a processor programmed to: periodically update the ERU database component with data supplied by the communications component; process queries to determine response capabilities of the emergency response units in the geographical area; and generate alerts based upon input received by the rules component for distribution by the communications component.

Still other aspects of the present invention are attained by a system for predicting potential threats, comprising: a database component operative to maintain a CA database identifying critical assets, their physical attributes and their physical location; a communications component for observing physical characteristics of the critical assets; a rules component operative with the database component; and a processor programmed to periodically update the CA database component with data supplied by the communications component; and perform automated process queries of the rules component to determine whether any one of the critical assets has a physical characteristic outside of a predetermined norm.

Yet other aspects of the present invention are attained by a computerized method for generating alert notifications, comprising: maintaining a database identifying a critical asset and a set of predetermined rules; receiving and applying input to said set of predetermined rules; and sending an alert notification to an agency if warranted by said set of predetermined rules.

### BRIEF DESCRIPTION OF THE DRAWINGS

For a complete understanding of the objects, techniques and structure of the invention, reference should be made to the following detailed description and accompanying drawings, wherein:

FIG. 1 is a schematic diagram of an exemplary system employed according to the present invention;

FIG. 2 is an operational flow chart implemented by the system setting forth the steps for generating alert notifications;

FIG. 3 is an operational flow chart implemented by the system setting forth the steps for alerting vulnerable targets to imminent threats; and

FIG. 4 is an operational flow chart implemented by the system setting forth the steps for response deployment.

### BEST MODE FOR CARRYING OUT THE INVENTION

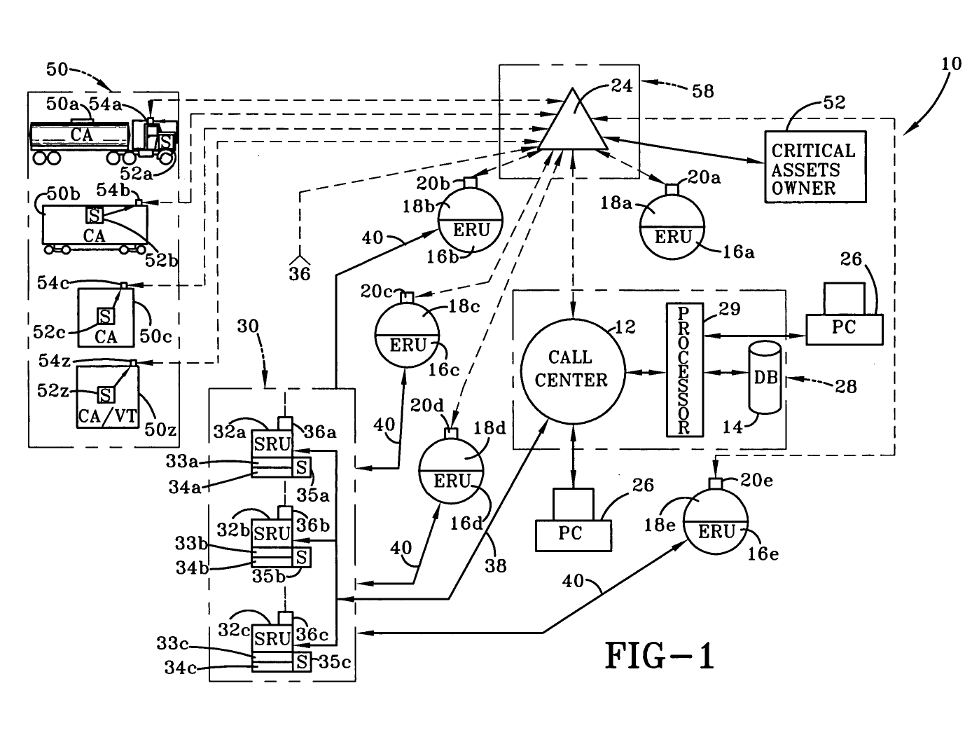

Referring now to the drawings and in particular to FIG. 1, it can be seen that an electronic emergency response management system is designated generally by the numeral 10. The system 10, at a minimum, includes a call center 12 which comprises a server or related computer device that is maintained by trained personnel. The call center 12 may be accessible via traditional phone systems, wireless phones, wireless internet devices via the internet or other appropriate communication link. As such, the call center 12 is a user-interface device capable of receiving and sending communications in any number of forms, including, but not limited to facsimile, page, email, voice text and instant messaging.

The call center 12 has access to a database (DB) 14 which is structured to store various components, including, but not limited to pertinent information related to any number of mobile emergency response units (ERU) 16. Each different emergency response unit or ERU has a separate and distinct alphabetic suffix. These response units may be located anywhere in a city, region or state. And the units may be part of a governmental agency, such as an ambulance; a private contractor that provides special cleanup capabilities for particular emergencies; or an internal company unit that has specific capabilities for particular materials that are shipped by that company. For example, one response unit may have a capability 18a that is specifically designed to clean up large quantities of oil. Another type of response capability, such as 18b, may include the ability to respond to releases of radioactive material. Each mobile response unit 16 is provided with a satellite or cellular device, also referred to as a beacon 20, that emits a unique identifiable signal which provides locational information, such as a global positioning signal, that is directed to a communications link 24 such as a satellite or wireless cell, a world wide web service or an appropriate communication link that is connected to the call center 12. Accordingly, the positional or locational information of each response unit 16 is provided to the call center 12 instantaneously or at least on a periodically updated basis. The unique identifiable signal may also provide status information about the response unit such as medicine and equipment inventory, operating range and related information.

A personal computer (PC) 26 or other similar user-interface type device is connectable to the call center 12 and database 14 so that the information stored therein may be accessed. The personal computer 26 may be directly connected to the call center 12, or it may be linked by the internet or dedicated telephone line, or even a wireless connection. Indeed, the call center 12, the database 14, and the personal computers 26 may be integrated with one another and supported by a processor-based computer system 28. The system 28 includes the necessary hardware, software and memory to implement the operations disclosed herein. The system includes a processor 29 that is capable of coordinating all the activities of the call center 12 such as routing messages and information, alerting the appropriate authorities and initiating “what if” scenarios. Moreover, the processor 29 coordinates access to the database; formats the contents of the database; and allows for changes, additions or deletions to the database records as needed.

The system 10 may also include any number of fixed or stationary response units designated generally by the numeral 30. Each stationary response unit or SRU has a separate and distinct alphabetic suffix. The stationary response units may be located in a city, region, or state in much the same manner as the mobile emergency response units. Particular response units are designated generally by the numeral 32. For example, a government response unit is designated as 32a, an internal stationary response unit is designated as numeral 32b, and a private contractor or “for hire” response unit is designated as numeral 32c. The government response units 32a may be a coordinating agency for a plurality of emergency response units 16 that have a particular capability. Typically, this capability would be a dispatching unit for the city or state. But, it will be appreciated that the government response unit 32a may be associated with some other emergency related function. Another type of response unit is the internal stationary response unit 32b. Unit 32b might be associated with freight carriers and the like. Accordingly, any dispatching of response teams for remediating or otherwise handling hazardous material may be coordinated with assistance from the call center by an internal response unit 32b. And, a “for-hire” response unit 32c would be available for either governmental or freight companies on an as needed basis. Each of these units 32 maintain certain resources or capabilities identified by the numeral 33 with alphabetic suffixes associated with each type of entity. Likewise, these units also maintain inventory designated generally by the numeral 34, wherein the alphabetic suffixes are associated with a particular unit. The units 32 are considered to be stationary inasmuch as they do not have any assets that can immediately respond to an on-site emergency in a timely manner. However, these units may maintain inventory of certain resources such as a large quantity of gas masks, specialized suits, medicines or other large quantities of material that would be required in responding to an environmental hazard or activation of a weapon of mass destruction. Moreover, these stationary response units may not have the inventory or resources in a fixed location, but the location of these resources is readily maintained and available to the coordinating agency.

All of these stationary response units 32 are in communication with the call center 12 and the resources and inventory of each unit are maintained in the database 14. Indeed, each stationary response unit may have a sensor 35 which assists in monitoring the location of specific resources and/or inventory, wherein this information is transmitted by a beacon 36. Although the units 30 are primarily stationary, wherein the resources/inventory are stored in warehouses or a secure location, the resources and/or inventory can be mobile when a situation requires that they be transported. Accordingly, the call center can monitor the status of the resources/inventory and can re-direct them in mid-transit if needed. A direct communication link 38 between the stationary response units 32 and the call center 12 assists in coordinating responses of the agency and/or owners responsible for a chemical spill or related incident. This direct communication link further facilitates the delivery of resources and any goods or services provided by the resources 33 and inventory 34. The call center 12 may also assist in re-ordering materials that are depleted in responding to any emergency event. There may also be provided direct communication links 40 between the stationary response units 30 and the mobile or emergency response units 16 to facilitate immediate decision making in responding to an event.

The system 10 may also be used to facilitate the tracking and monitoring of critical assets (CA) designated generally by the numeral 50. The critical assets may either be movable or stationary objects and these are defined by suffix designations associated therewith. These critical assets may also be classified as convertible to a potential weapon, or as a vulnerable target. For example, critical asset 50a may be a movable item such as a cargo plane, freight truck or boat. Critical asset 50b may be a container device that is carried by ships or trains. And critical asset 50c may be a package for delivery that contains some type of critical material or asset that is shipped by a commercial carrier or an asset that is carried and delivered by a private contractor. Any of these critical assets, in the wrong hands may be converted into a potential weapon. For example, a tanker truck carrying gasoline that is hijacked could be used as a weapon to attack public buildings. A fixed or stationary critical asset may be designated generally by the numeral 50z wherein such a stationary critical asset may be a power plant, a water reservoir, any type of public utility and the like. Accordingly, such a stationary critical asset may be classified as a vulnerable target, which is designated as CA/VT in FIG. 1. It is even possible that a critical asset could be classified as both a potential weapon and a vulnerable target such as in the case of a cruise ship or passenger jet. It will also be appreciated that the emergency and stationary response units may also be classified as an “asset.” The response assets may have their own specific types of physical attributes and location and, as will become apparent, are monitored and communicate with the call center in much the same way as the critical assets.

Each of the critical assets 50 may be equipped with at least one sensor 52 wherein the sensors may be utilized to monitor certain aspects or features of a particular critical asset. For example, on a tractor trailer, the sensor 52b could be used to detect the rate of speed, sudden deceleration, trailer disconnect, unlock truck and trailer doors and tank valves. A sudden loss of contact from one of the sensors, as monitored by the call center 12, caused by defeating the tracking of the communication system on-board the asset itself, is itself data which could be provided to the call center 12. In order to relay this information from the sensors 52a, a beacon 54 is installed on each of the critical assets 50. Accordingly, when data is received from a sensor 52 via the beacon 54, an alert may be created in the form of a fax, page, email or voice text message and delivered to the call center 12. It will be appreciated that the use of a sensor with a critical asset is not required to practice the present invention. For a critical asset 50z, such as a sports stadium, the system 10 may function based upon input provided by the owner of the stadium and/or appropriate governmental response agencies.

An appropriate program maintained by the processor system 29 continually monitors the data received and creates an alert when abnormal transferred data is detected. This information may then be used by the call center 12 to alert the appropriate response unit 16 via satellite or cellular communication or, in the alternative, alert and direct the information to the stationary response unit 30. Since time is of the essence in responding to potential threats or actual events, the processor 29 may be programmed to automatically issue “need-to-know” communications in the proper form to the appropriate unit 16, unit 30, or asset 50. For example, if a sensor 52a detects that a tanker truck 50a has spilled a large quantity of gasoline, this information is immediately transmitted by the beacon 54a to the call center 12. The processor 29 is programmed to recognize such an event and can immediately dispatch an appropriate form of communication via the beacons of the appropriate response units 16 which can then extinguish any fires and clean-up the spill.

The call center 12 can be configured to analyze the data received to look for patterns which may be associated with increased risks of weapons of mass destruction threats or accidents to carriers of hazardous materials. For example, the on-board system of a truck 50a may send real-time data via the beacon 54a indicating that the vehicle is speeding on a particular interstate highway. Information contained within the call center database allows for the truck's bill of lading to be searched and it could be determined that the truck is carrying a material which is poisonous by inhalation. Moreover, the database 14 may maintain map information of pre-identified features such as the interstate highway system, population centers, the location of hospitals, schools and stadiums, and the like, and indicate that the truck is heading toward a populated place and, in particular, toward a school or stadium adjoining the interstate highway. Accordingly, this pattern; a speeding truck, containing a particular hazardous material, near a school or stadium, poses a significant threat and an alert will be automatically distributed to the appropriate emergency units and stationary response resources. The processor 29 may also be programmed to monitor multiple critical assets in conjunction with other current events and predict the possibility of a terrorist event. For example, if it is detected that four gasoline tanker trucks—critical assets—are diverted from their expected route of travel and are converging upon a civic landmark—a critical asset classified as a vulnerable target—, the processor 29 can automatically issue alert notices to authorities to stop the trucks in transit, block off the suspected target area, and alert the appropriate units capable of responding to a potential conflagration. As will be discussed, alert notifications may also be sent to owners and/or administrators of the critical asset. This predictive nature of the system 10 can be used to stop an attack before it comes to fruition and enable an immediate response to minimize loss of life and property damage.

In operation, the database 14 is loaded with the desired information. It is envisioned that states or local governments may require all of their particular emergency and stationary response units to load or provide their information to the database 14. Likewise, private contractors with specialized abilities in cleaning up various types of spills or dealing with particular types of chemicals may also maintain their capabilities on the database so that local municipalities, state governments or other governmental agencies will be able to retain the private contractor's services. This information will include at least the available response personnel, their equipment, expendable materials and disposal capabilities. Each entity that registers their particular capability is provided with an identification code and a password to allow access to the database. And when the occasion arises, the local municipality may access this database information to determine response capabilities and the like. Each entity may then install sensors and a beacon at a secure location on the emergency or stationary response unit or critical asset. It will be appreciated that if the response unit or critical asset is stationary or within a defined location, then the only information that needs to be loaded for the unit or asset is an address and related pertinent information. It is envisioned that the database 16 will include mapping information that shows precisely where the response units are located and where an “event” which requires an emergency response has occurred. The map information will preferably include information about population densities, the location of hospitals, water supplies, schools, and the like. Prevailing weather conditions may also be incorporated into and be accessible by the system 28. For example, it may be helpful to know the wind and rain conditions in an area where chemical release has taken place. All this information could then be used to quickly determine the number of people that may be affected and what assets are required to mitigate the situation and where those assets are located.

Based upon the information stored in the database 14 any governmental agency or properly authorized entity may access the database and enter “what-if” scenarios to determine their ability to respond to any given calamity or natural disaster. In this way agencies can determine whether they are over-staffed in particular areas and/or under-staffed in others or whether particular response capabilities exist in one location but not another. This improves the ability to plan for any number of occurrences and if needed to dispatch the appropriate emergency response unit to an actual disaster situation. It is believed that this combined technology and integrated service offering provides access to resources and information not available by any known system. Further, it is believed that no such system exists for responding to weapons of mass destruction and terrorism threats. These combined technologies and integrated service offerings enable local, state and federal governments to gain access to available resources and provide industry with greater control to respond more quickly and with greater accuracy. The system 10 may also be used to predict potential threats and proactively communicate the potential threat to the appropriate authority. Likewise, the system 10 can detect via the sensors 35, 52 a potential problem with the asset or unit so that an immediate on-site investigation can begin. Accordingly, such a system is advantageous inasmuch as it provides a timely way for system activation to occur in under three minutes with a reliable assessment of response capabilities by utilizing the wireless technology provided with each emergency response unit.

The system 10 can be further enhanced with the use of an automated rule-based alert notification and response deployment feature. This enhancement is enabled by the incorporation of a telematics provider designated generally by the numeral 58 in FIG. 1. The telematics provider encompasses the communication link 24 that is in contact with the call center 12. In other words, the telematics provider 58 is enabled to receive communications from the various beacons and sensors associated with the response assets such as the emergency response units and the stationary response units; the critical assets; and the call center. Although the preferred form of communication with the telematics provider are wireless signals, it will be appreciated that the data communicated through the telematics provider may be a proprietary system which utilizes satellite, terrestrial Wi-Fi according to the IEEE 802.11 standards, sub-frequency modulation technology, or any other communication technology as it becomes available. The various beacons 20 and sensors 35/52 described above may employ sensor technology such as radio frequency identifications tags in any of their various forms; sensors that monitor weather, road conditions; bridge conditions or any type of sensor linked with an on-board computer device, electrical device or any instrument that is able to transmit information by the telematics provider to the database maintained by the call center.

Also linked with the system 10 is a critical asset owner designated generally by the numeral 52. The owner 52 is linked with the telematics provider 58 and as such with the call center 12 either directly or indirectly. The owner 52 may be responsible for any type of critical asset 50 such as planes, trains, and cargo ships regardless of whether the assets are either mobile or stationary. In other words, the owner of the critical assets 50, by subscribing to the services provided by the call center 12, are able to comprehensively track all of their assets and detect patterns of those assets and in particular detect abnormal activities that deviate from the patterns or procedures established by the owner. And if the asset is classified as a vulnerable target, the owner may respond according to any pre-existing emergency response policy. Communications between the critical asset owner 52, critical assets 50 and agencies representing the various emergency response units 16 and the stationary response units 30 is enhanced by providing a rule-based system in the processor 29 so that designated plans may be implemented in the event of suspicious activity or scenarios that individually would not raise concern but collectively give rise to threats to public safety.

The rule-based system may be implemented with the use of three modules either separately or together. The first module is directed to alert notification to owners of critical assets and governmental agencies which are likely responsible to respond to problems with the critical asset on behalf of the public interest. A second module is directed to vulnerable target “owners”—those entities responsible for assets that may be classified as vulnerable targets—so that they may be immediately notified upon the determination of increased risks or threats as detected by the various telematic devices. In other words, the telematic devices, which may not be directly associated with the vulnerable target, provide data that collectively indicate a level of risk to the critical asset. And finally, the third module is directed to owners of response resources, such as governmental agencies and the like, so that they may receive event notices from the call center and respond in a pre-determined manner to ensure that the appropriate resources are delivered to the critical asset or vulnerable target in an efficient and responsive way.

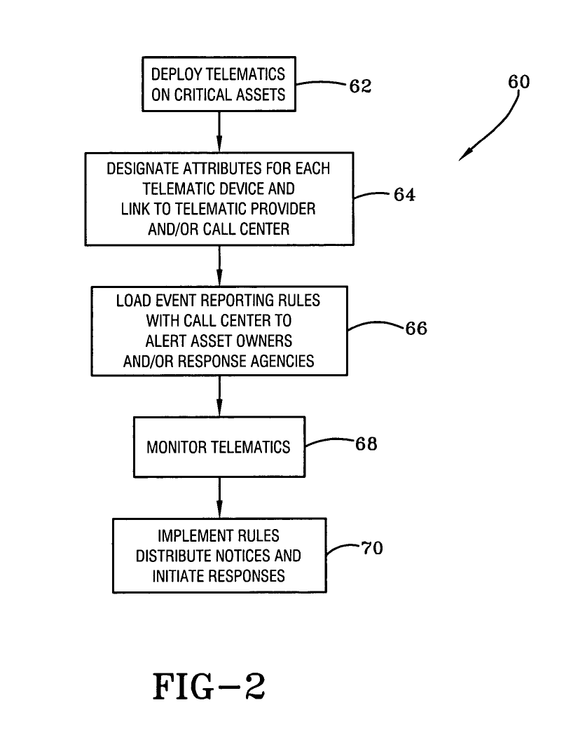

Referring now to FIG. 2 an operational flow chart for the purpose of alert notification is designated generally by the numeral 60. Initially, at step 62, the owner of the critical assets deploys telematics devices on their respective critical assets or if no telematic devices are associated with a vulnerable target type of critical asset, the owner may simply provide an address. Following this at step 64 the owner designates attributes for each telematics device and links the device through the telematics provider to the call center 12. In the alternative, if no telematic devices are directly associated with the asset, the owner may provide pertinent information to the call center. Of course, the telematics device may be directly linked to the call center. The critical asset owner may then load event reporting rules with the call center database to alert asset owners and/or response agencies upon the occurrence of certain events associated with the telematics devices. It will be appreciated that these rules are modifiable and may be updated on a periodic basis or may be implemented upon other conditions observed by the call center. Such variables may be related to weather, terrorist threat levels designated by the government or other conditions. At step 68, the various telematics devices are monitored by the telematics provider and/or the call center and at step 70, the call center implements the rules and distributes the notices and initiates responses as instructed by the asset owners. It will be appreciated that the telematics provider may send event messages and data to the critical asset owners via a web services interface or proprietary software. The telematics provider may also send event messages and data to the call center by the web services interface or directly if deemed appropriate. And the event messages and data may be sent at the direction of the asset owner to a government agency as required by law. The asset owners typically will provide instructions via the secured website to the call center. The instructions preferably describe steps to be taken or work to be performed when event messages or data is received from the telematics provider. It will be appreciated that the rules are installed in a rules engine software program maintained by the processor 29. If desired, the rules may be referenced by color or name. It will also be appreciated that the owners may authorize the call center to alert local, state, and federal response, enforcement and defensive agencies as deemed appropriate. It will further be appreciated that the above-mentioned agencies may provide instructions via a security website to the call center. These instructions set forth the steps to be taken to notify the agencies and other appropriate individuals at the direction of the agency when event messages or data is received from the telematics provider or directly from the critical asset.

The rules implemented by the asset owners and the response agencies may be exemplified in the following scenario. If a vehicle with an unauthorized driver, containing material which is a poison inhalation hazard is off-route in Bentonville, Ark., the trucking company along with the Bentonville Police will receive an alert via email, fax and phone which will provide vehicle, location, material and response information. Similarly, the Bentonville Fire Department Hazmat Team, the Bentonville EMS and the Arkansas Department of Fire services Hazmat will receive near real-time alerts. For-hire responders who specialize in poison inhalation hazards will receive email, fax and phone alerts instructing them to standby for dispatch by Bentonville authorities.

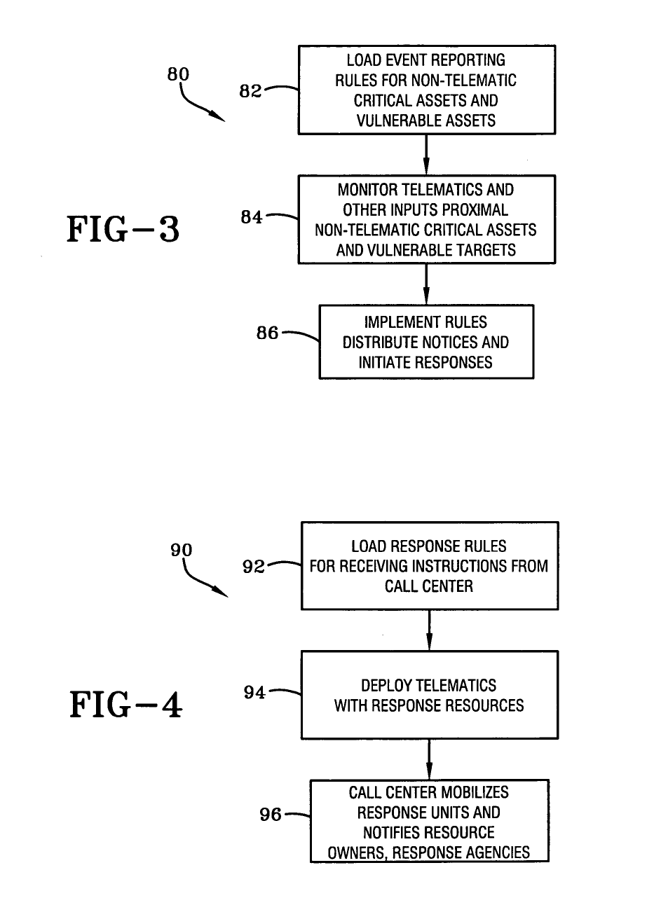

Referring now to FIG. 3, it will be appreciated that an additional module may be incorporated and implemented in the processor 29 for the purpose of allowing potential vulnerable targets to receive proper notification. In other words, the vulnerable target owners may identify and provide response instructions via a secure website to the call center. These target identification rules include a description of the target and its precise location which may be incorporated into the previously mentioned mapping component. The response instructions describe steps to be taken or work to be performed when event messages or data is received which suggests that a vulnerable target is at risk. Moreover, the instructions may take the form of rules written into the rules engine software program. As noted previously, these rules may be referenced by a color or name or other indicia.

The specific steps taken are designated generally by the numeral 80 in FIG. 3. As a first step, step 82, the owner of the vulnerable target enters event reporting rules for non-telematic critical assets and vulnerable targets. In other words, these particular assets likely do not have telematic devices associated therewith and as such rely on telematics devices in the associated vicinity such as when certain scenarios arise in close proximity to the potential vulnerable target. As indicated at step 84, the call center and/or telematics provider monitors telematics and other inputs proximal the non-telematic vulnerable targets and at step 86 implements the rules previously loaded to distribute notices and initiate responses. The other input proximal the vulnerable target may include, but are not limited to, weather conditions, traffic patterns, public event schedules, reports associated with other similar vulnerable targets and the like.

The following table is exemplary of the type of condition and what type of signal is generated based on that condition. Each signal is then designated a color code, which in turn indicates who a notice should be sent to. The form of the notice can also be specified.

| | | Priority | |
|---|---|---|---|
| Condition | Telematics Signal | Code | Notice to: |
| Driver Alert | Un-Authorized | Red | Carrier & Agency |
| Off-Route | Off-Route | Green | Carrier |
| HazMat Off-Route | HazMat and Off- | Yellow | Carrier & Agency |
| | route | | |
| Unintentional Release | Unintentional | Red | Carrier & Agency |
| | HazMat Release | | |
| Intentional Release | Intentional HazMat | Red | Carrier & Agency |
| | Release | | |
| Driver HazMat | Un-Authorized and | Red | Carrier & Agency |
| | HazMat | | |
| Driver Off-Route | Un-Authorized and | Red | Carrier & Agency |
| | Off-Route | | |
| Driver HazMat Off- | Un-Authorized and | Red | Carrier & Agency |
| Route | HazMat and Off- | | |
| | Route | | |
| Panic | Panic button | Red | Carrier & Agency |
| Panic HazMat | Panic button and | Red | Carrier & Agency |
| | HazMat | | |

Referring now to FIG. 4, a response deployment module is designated generally by the numeral 90. Initially, the alert notification system at step 92 requires the aforementioned governmental agencies or response agencies to load response rules for receiving instructions from the call center. Next, at step 94, the various response agencies deploy telematic devices with the response resources. Finally, a step 96, the call center mobilizes the response unit and notifies resource owners and response agencies at step 96 based upon implementation of the previously loaded response rules.

The foregoing steps require that the response resource “owners” identify their response resources and provide instructions by a secure website linked to the call center. The response resource identification includes a detailed description of inventory, including equipment materials and trained personnel associated with each of the resources. This may also include precise resource location and the response area served. The resource instructions or rules describe the steps to be taken or work to be performed when a call center receives event messages or data from a telematics provider or directly from the critical asset.

Utilizing the examples described above the response deployment may be implemented in the following exemplary scenario. If a local law enforcement agency has been alerted to an incident involving a vehicle with an unauthorized driver, which contains a poison inhalation hazard, and the vehicle is off-route, the alert will include contact information for the closest public and private responders who specialize in poison inhalation hazards. These local responders will have received email, fax and phone alerts instructing them to standby for dispatch by local authorities.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. A computerized method for identifying matches between emergency response units and a response event comprising:
identifying a group of emergency response units (ERU), each said emergency response unit having particular physical attributes;
installing an ERU beacon on each said ERU, said ERU beacon emitting a unique identifiable ERU signal;
maintaining a database identifying each ERU, their corresponding physical attributes, and a location based on said unique identifiable ERU signal;
loading into said database a set of rules associated with each said ERU;
accessing said database to determine area response capabilities for a particular type of response event needing physical attributes provided by said group of ERUs;
applying said unique identifiable ERU signals to said set of rules; and
generating at least one alert based upon matching of said unique identifiable ERU signal with at least one of said rules.

2. The method according to claim 1, further comprising:
identifying a group of critical assets (CA), each said CA having particular physical attributes;
installing a CA beacon on each said CA, said CA beacon emitting a unique identifiable CA signal;
maintaining on said database, each CA, each CA's corresponding physical attributes, and a location based upon said unique identifiable CA signal; and
monitoring said group of CA.

3. The method according to claim 2, further comprising:
installing at least one sensor on each said CA which is in communication with said CA beacon and generating an alert signal when appropriate, wherein said monitoring step monitors each said CA and alerts an appropriate ERU whenever said alert signal is generated.

4. The method according to claim 3, further comprising:
maintaining a map in said database with pre-identified features; and
alerting an appropriate ERU whenever one of said CAs is within a predetermined distance of one of said pre-identified features.

5. The method according to claim 4, further comprising:
identifying a group of stationary response units (SRU), each said SRU capable of communicating with select ERUs; and
including in said database a location of each said SRU and an inventory of items maintained at each said SRU.

6. The method according to claim 5, further comprising:
providing a call center which maintains said database and communication links with said ERUs, CA, and SRUs.

7. The method according to claim 6, further comprising:
generating an alert signal when said at least one sensor is disconnected.

8. The method according to claim 7, further comprising:
maintaining a direct communication link between selected ERUs and selected said SRUs.

9. The method according to claim 1, further comprising:
automatically sending said at least one alert to an agency as defined by said set of rules.

10. The method according to claim 1, further comprising:
routing said unique identifiable ERU signal through a telematics provider and than to a call center which maintains said database.

11. The method according to claim 10, further comprising:
loading said set of rules into a limited access website maintained on a global computer information network.

12. The method according to claim 11, further comprising:
designating a priority code for each rule in said set of rules.

13. A system for identifying emergency response capabilities in a geographical area, comprising:
a database component operative to maintain an ERU database identifying emergency response units, their physical attributes and their physical location;
a communications component for observing physical locations of said emergency response units a rules component operative with said database component; and
a processor programmed to:
periodically update said ERU database component with data supplied by said communications component;
process queries to determine response capabilities of the emergency response units in the geographical area; and
generate alerts based upon input received by said rules component for distribution by said communications component.

14. The system according to claim 13, further comprising:
said database component operative to maintain a CA database component identifying critical assets, their physical attributes and their physical location, said communications component observing physical locations of said critical assets;
said processor programmed to:
update said CA database component with data supplied by said communications component; and
process queries to determine the status of said critical assets and determine response capabilities of the emergency response units.

15. The system according to claim 14, further comprising:
at least one sensor coupled to each said critical asset and linked to said communications component, said sensor sending an alert signal upon detection of an abnormal event via said communications component; and
said processor notifying appropriate emergency response units via said communications component upon receipt of said alert signal.

16. The system according to claim 15, further comprising:
said database component further operative to maintain a mapping component, said communications component alerting at least said emergency response units when one of said critical assets is in proximity to pre-designated areas in said mapping component.

17. The system according to claim 16, wherein said processor monitors inventory of said stationary response units and issues on alert via said communications component when said fixed response resources inventory reaches a predetermined level.

18. The system according to claim 13, further comprising:
said database component operative to maintain a SRU database component identifying stationary response units, their physical attributes, and their physical location, said communication component linked to said fixed response resources; and
said processor linking said fixed response resources to said emergency response units when appropriate.

19. The system according to claim 18, further comprising:
said database component operative to maintain a CA database component identifying critical assets, their physical attributes and their physical location, said communications component observing physical locations of said critical assets;
said processor programmed to:
update said CA database component with data supplied by said communications component; and
process queries to determine the status of said critical assets and determine response capabilities of the emergency response units.

22. A system for predicting potential threats, comprising:
a database component operative to maintain a CA database identifying critical assets, their physical attributes and their physical location;
a communications component for observing physical characteristics of said critical assets;
a rules component operative with said database component; and
a processor programmed to:
periodically update said CA database component with data supplied by said communications component; and
perform automated process queries of said rules component to determine whether any one of said critical assets has a physical characteristic outside of a predetermined norm.

23. The system according to claim 22, wherein said processor is programmed to generate an alert signal when any one of said critical assets has a physical characteristic outside of said predetermined norm as determined by said rules component.

24. The system according to claim 22, further comprising:
said database component operative to maintain an RU database component identifying response units, their physical attributes and their physical location, said communications component observing physical locations of said response units;
said processor programmed to:
update said RU database component with data supplied by said communications component; and
analyzes trends associated with said physical characteristics to predict potential emergency events.

25. The system according to claim 24, wherein said processor is programmed to:
generate an appropriate alert signal to said response units best able to respond to the potential emergency events.

26. The system according to claim 25, wherein said processor is programmed to:
generate said appropriate alert signals to agencies designated by said rules component.

27. The method according to claim 26, wherein said processor is programmed to designate code levels with said alert signals.

28. A computerized method for generating alert notifications, comprising:
maintaining a database identifying at least one asset and a set of predetermined rules associated with said at least one asset;
receiving and applying input to said set of predetermined rules; and
sending an alert notification to an agency if warranted by implementation of said set of predetermined rules.

29. The method according to claim 28, further comprising:
deploying at least one telematics device on at least one critical asset;
generating an event message by said telematics device upon detection of an event; and
receiving and applying said event message to said set of pre-determined rules.

30. The method according to claim 29, further comprising:
associating a sensor with each said telematics device; said sensor monitoring for the occurrence of said event.

31. The method according to claim 29, further comprising:
distributing said alert notification to an owner of said at least one critical asset associated with said event message according to said set of pre-determined rules.

32. The method according to claim 29, further comprising:
distributing said alert notification to a governmental agency in a format established by said set of pre-determined rules.

33. The method according to claim 28, further comprising:
coordinating maintenance of said database, said set of pre-determined rules, and said alert notifications by a call center.

34. The method according to claim 28, further comprising:
deploying at least one telematics device on at least one response unit; and
routing said alert notification to said at least one response unit's telematics device according to said set of pre-determined rules.

35. The method according to claim 34, further comprising:
notifying an agency responsible for said response unit that receives said alert notification.

36. The method according to claim 28, further comprising:
notifying an owner of at least one critical asset in a manner defined by said set of predetermined rules.

37. The method according to claim 36, further comprising:
monitoring events associated with said critical asset and determining a risk level according to said set of predetermined rules.

38. A system for generating alerts comprising:
a database component operative to maintain an asset database identifying assets, their physical attributes and their physical location;
a communications component;
a rules component operative with said database; and
a processor programmed to:
monitor inputs received from sources via said communications component or otherwise applicable to said assets;
generate alert notices via said communications component when said monitored inputs are applied to said rules component and deemed to qualify as an event.

39. The system according to claim 38, wherein said processor is programmed to receive inputs from a telematics provider via said communications component, wherein said telematics provider is linked to said sources.

40. The system according to claim 39, wherein said processor is programmed to distribute said alert notices to owners of said asset in a format defined by said rules component.

41. The system according to claim 39, wherein said processor is programmed to distribute said alert notices to agencies defined by owners of said asset in a format requested by said agencies and defined by said rules component.

42. The system according to claim 38, wherein said processor is programmed to receive inputs from sources designated by said asset owner via said communications component.

43. The system according to claim 42, wherein said processor is programmed to distribute said alert notices to owners of said asset in a format defined by said rules component.

44. The system according to claim 42, wherein said processor is programmed to distribute said alert notices to agencies defined by owners of said asset in a format requested by said agencies and defined by said rules component.

45. The system according to claim 38, wherein said processor is programmed to generate said alert notices via said communications component for receipt by a telematics provider linked with, said asset in a format defined by said rules component to deployment of said asset.

46. The system according to claim 38, wherein said processor is programmed to generate said alert notices via said communications component for receipt by a telematics provider linked with, said asset in a format defined by said rules component to deployment of said asset for notification of agencies defined by owners of said asset in a format requested by said agencies and defined by said rules component.
